(19) United States
(12) Patent Application Publication
(10) Pub. No.: US 2026/0113183 A1
(43) Pub. Date: Apr. 23, 2026

(54) System and method for encoding and encrypting sensitive data based on quantum entanglement

(71) Applicant: Bank of America Corporation, Charlotte, NC (US)

(72) Inventors: Adam K. King, Fort Mill, SC (US); James Siekman, Charlotte, NC (US); Sanjay Lohar, Mint Hill, NC (US); Matthew K. Bryant, Mt. Holly, NC (US); Catherine Cunningham, Charlotte, NC (US); Takiyah Watford, Fort Mill, SC (US); Elizabeth Swanzy-Parker, Charlotte, NC (US); Peter Nein, Waxhaw, NC (US)

(21) Appl. No.: 18/923,798

(22) Filed: Oct. 23, 2024

(51) Int. Cl. H04L 9/08

(52) U.S. Cl. CPC H04L 9/0852; H04L 9/0869

(57) ABSTRACT

A system includes a quantum memory configured to store a quantum cryptographic key, a unique random key, and sensitive data to be transmitted to a quantum computing device over an optical communication channel. The system further includes a quantum processor operably coupled to the quantum memory and configured to access the quantum cryptographic key and the sensitive data and to transmit, over the optical communication channel, the quantum cryptographic key to the quantum computing device. In response to transmitting the quantum cryptographic key to the quantum computing device, the quantum processor is further configured to encode the sensitive data based on the quantum cryptographic key and a unique random key. The encoded sensitive data includes a generated one or more pairs of entangled quantum bits (Qubits). The quantum processor is further configured to transmit, over the optical communication channel, the encoded sensitive data to the quantum computing device.

### TECHNICAL FIELD

The present disclosure relates generally to quantum computing, and, more specifically, to a system and method for encoding and encrypting sensitive data based on quantum entanglement.

### BACKGROUND

Existing public-key encryption algorithms, such as Rivest-Shamir-Adleman (RSA) encryption algorithms, face significant challenges in ensuring the security of communication channels against sophisticated cyberattacks and cyberthreats, such as those that may be implemented utilizing quantum computing. Specifically, existing RSA encryption algorithms rely on the assumption that factoring large prime numbers is computationally intensive for classical computing systems, and thus ensure the secure transmission and reception of sensitive data over communication channels. However, because quantum computing systems may be especially suited for “cracking” RSA encryption algorithms rather trivially (e.g., by way of Shor's algorithm), “harvest now, decrypt later” (HNDL) attacks may allow an attacker, an eavesdropper, or other adversarial user to intercept and store encrypted data until a future time at which quantum computing systems and resources are more feasible and readily available to decrypt the intercepted and harvested encrypted data.

### SUMMARY

The system and methods implemented by the system as disclosed in the present disclosure provide technical solutions to the technical problems discussed above by providing systems and methods for encoding and encrypting sensitive data based on quantum entanglement. The disclosed system and methods provide several practical applications and technical advantages. Specifically, the present embodiments improve the security and network efficiency of optical communications channels by encoding and encrypting sensitive data based on quantum entanglement.

Specifically, the present embodiments provide a quantum computing system that may be utilized to encode and encrypt sensitive data to be transmitted over an optical communication channel to a quantum computing device based on a secret quantum cryptographic key shared between the quantum computing system and the quantum computing device and a unique random key generated in accordance with a one-time pad (OTP) encryption process. In accordance with the presently disclosed embodiments, the quantum computing system may encode the sensitive data by generating one or more pairs of entangled quantum bits (Qubits) and encoding the sensitive data utilizing the one or more pairs of entangled Qubits.

The quantum computing system may then further encrypt the underlying sensitive message (e.g., plaintext message) included in the encoded sensitive data utilizing the secret quantum cryptographic key and the unique random key. In this way, a quantum state of each entangled QuBit of each pair of the one or more pairs of entangled QuBits representing the encoded sensitive data may be inextricably associated with the underlying sensitive message (e.g., plaintext message) being encrypted, such that any unauthorized observance (e.g., a measurement) of an entangled QuBit may indicate a security compromise of the underlying sensitive message (e.g., plaintext message).

Thus, in accordance with the presently disclosed embodiments, the one or more pairs of entangled QuBits may create a quantum entanglement system (e.g., an entangled state) with respect to the encoded sensitive data and the corresponding decoded sensitive data, such that as the encoded sensitive data is transmitted from the quantum computing system to the quantum computing device over the optical communication channel, any unauthorized observance (e.g., a measurement) of even one entangled QuBit of each pair of the one or more pairs of entangled QuBits may be identified and detected by the quantum computing system. In such an instance, the quantum computing system may then destroy (e.g., render unreadable, indecipherable, or inoperable) one or more of the secret quantum cryptographic key shared between the quantum computing system and the quantum computing device, the one or more pairs of entangled QuBits and the unique random key.

Accordingly, utilizing the quantum computing system and leveraging the principles of quantum entanglement, the present embodiments improve the security and network efficiency of optical communications channels by encoding and encrypting sensitive data based on quantum entanglement. Specifically, in accordance with the principles of quantum entanglement, QuBits interact with each other and are represented by reference to one another, regardless of whether the QuBits are spatially close together or separated spatially by a large distance. For example, at the time of measurement, if one entangled QuBit in a pair of entangled QuBits is determined to be in a spin state of “down,” the quantum computing system may then immediately configure the other entangled QuBit in the pair of entangled QuBits to assume the opposite spin state of “up,”for example.

That is, in accordance with the principles of quantum entanglement, QuBits, even those that are spatially far away from each other, interact instantaneously with each other. In this way, if an attacker, an eavesdropper, or other adversarial user interacts with even just one QuBit of a pair of entangled QuBits, the other one QuBit of the pair of entangled QuBits will also be instantaneously impacted by the interaction (e.g., regardless of whether the individual QuBits are spatially close together or separated spatially by a large distance). Accordingly, utilizing the quantum computing system and leveraging the principles of quantum entanglement, the present embodiments improve the security and network efficiency of optical communications channels by encoding and encrypting sensitive data based on quantum entanglement, which ensures secure sensitive data communications between sending quantum computing systems and receiving quantum computing systems and the secure transmission and reception of sensitive data over optical communication channels.

Additionally, even though quantum computing systems may be especially suited for “cracking” RSA encryption algorithms rather trivially (e.g., by way of Shor's algorithm), the present embodiments further obviate the threat of “harvest now, decrypt later” (HNDL) attacks by encoding and encrypting sensitive data based on quantum entanglement that is wholly independent of traditional RSA encryption algorithms.

The present embodiments are directed to systems and methods for encoding and encrypting sensitive data based on quantum entanglement. In particular embodiments, a system includes a quantum memory configured to store a quantum cryptographic key and sensitive data to be transmitted to a quantum computing device over an optical communication channel. In particular embodiments, the system may further include one or more quantum processors operably coupled to the quantum memory and configured to access the quantum cryptographic key and the sensitive data to be transmitted to the quantum computing device. In particular embodiments, the one or more quantum processors may be configured to transmit, over the optical communication channel, the quantum cryptographic key to the quantum computing device.

In particular embodiments, the quantum computing device may be configured to receive the transmission of the encoded sensitive data and to decrypt the encoded sensitive data based at least in part on the quantum cryptographic key and the unique random key. In particular embodiments, in response to transmitting the quantum cryptographic key to the computing device, the one or more quantum processors may be configured to encode the sensitive data based at least in part on the quantum cryptographic key and a unique random key. In one embodiment, the encoded sensitive data may include a generated one or more pairs of entangled quantum bits (Qubits).

In particular embodiments, the one or more pairs of entangled Qubits may include one or more pairs of entangled photons, one or more pairs of entangled electrons, one or more pairs of entangled neuronal impulses, or one or more pairs of entangled subatomic particles. In particular embodiments, the quantum computing device may be configured to receive the transmission of the encoded sensitive data and to decrypt the encoded sensitive data based at least in part on the quantum cryptographic key and the unique random key. For example, in particular embodiments, the sensitive data may include a sensitive message to be transmitted to the quantum computing device.

In particular embodiments, the one or more quantum processors may be further configured to encode the sensitive data based at least in part on the quantum cryptographic key and the unique random key to generate a ciphertext message, and transmit the ciphertext message to the quantum computing device. In particular embodiments, the one or more quantum processors may be further configured to encode the sensitive data based at least in part on the quantum cryptographic key and the unique random key to generate the ciphertext message in accordance with a one-time pad (OTP) encryption process.

In particular embodiments, prior to encoding the sensitive data based at least in part on the quantum cryptographic key and the unique random key, the one or more quantum processors may be further configured to identify, based at least in part on one Qubit of each pair of the one or more pairs of entangled QuBits, an observance of the quantum cryptographic key during the transmission of the quantum cryptographic key to the quantum computing device, and in response to identifying the observance of the quantum cryptographic key, destroy the quantum cryptographic key. In particular embodiments, the one or more quantum processors may be further configured to generate the unique random key, and subsequent to encoding the sensitive data based at least in part on the quantum cryptographic key and the unique random key, destroy the unique random.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a combined classical computing and quantum computing system and network, in accordance with certain aspects of the present disclosure;

FIG. 2 illustrates a diagram of a quantum entanglement based encoding and encryption architecture for encoding and encrypting sensitive data based on quantum entanglement, in accordance with one or more embodiments of the present disclosure; and

FIG. 3 illustrates a flowchart of an example method for encoding and encrypting sensitive data based on quantum entanglement, in accordance with one or more embodiments of the present disclosure.

### DETAILED DESCRIPTION

### Example System

### System Overview

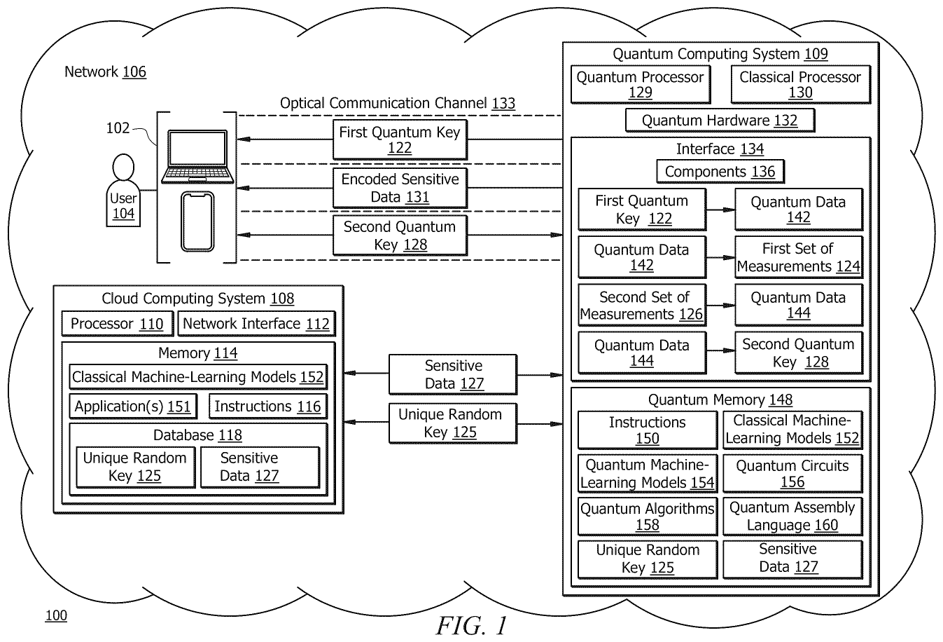

FIG. 1 is a block diagram of a combined classical computing and quantum computing system 100. As depicted, the combined classical computing and quantum computing system 100 may include one or more computing devices 102 that may be associated with a user 104, a cloud computing system 108, a quantum computing system 109, and a network 106 that enables the communications between the one or more computing devices 102, the cloud computing system 108, and the quantum computing system 109. In particular embodiments, the cloud computing system 108 and the quantum computing system 109 may be owned and managed by a single entity or organization, and thus, in some embodiments, the cloud computing system 108 and the quantum computing system 109 may operate in conjunction and/or may be integrated to operate as a singular computing infrastructure. In general, the combined classical computing and quantum computing system 100 may be utilized to encode and encrypt sensitive data based on quantum entanglement.

In another embodiment, one of the cloud computing system 108 and the quantum computing system 109 may be owned and managed by the single entity or organization while the other one of the cloud computing system 108 and the quantum computing system 109 may be owned and managed by a third-party entity or organization and licensed to be utilized by the single entity or organization. In one embodiment, the cloud computing system 108 may include a classical computing system suitable for executing binary or bitwise processing operations. In contrast, the quantum computing system 109 may include a quantum computing system suitable for executing superposed and entangled or quantum bit (QuBit) based parallel processing operations.

### Network

Network 106 may be any suitable type of wireless and/or wired network. The network 106 may or may not be connected to the Internet or public network. The network 106 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near field communication (NFC) network, and/or any other suitable network. The network 106 may be configured to support any suitable type of communication protocol as would be appreciated by one of ordinary skill in the art.

### Computing Device

Computing device 102 is generally any device that may be utilized to process data and interact with a user 104. Examples of the computing device 102 include, but are not limited to, a personal computer, a desktop computer, a workstation, a server, a laptop, a tablet computer, a mobile phone (such as a smartphone), etc. The computing device 102 may include a user interface, such as a display, a microphone, keypad, or other appropriate terminal equipment usable by the user 104. The computing device 102 may include a hardware processor, memory, and/or circuitry (not explicitly shown) configured to perform any of the functions or actions of the computing device 102 described herein. For example, a software application designed using software code may be stored in the memory and executed by the processor to perform the functions of the computing device 102. The computing device 102 may be utilized to communicate with other components of the system 100 via the network 106.

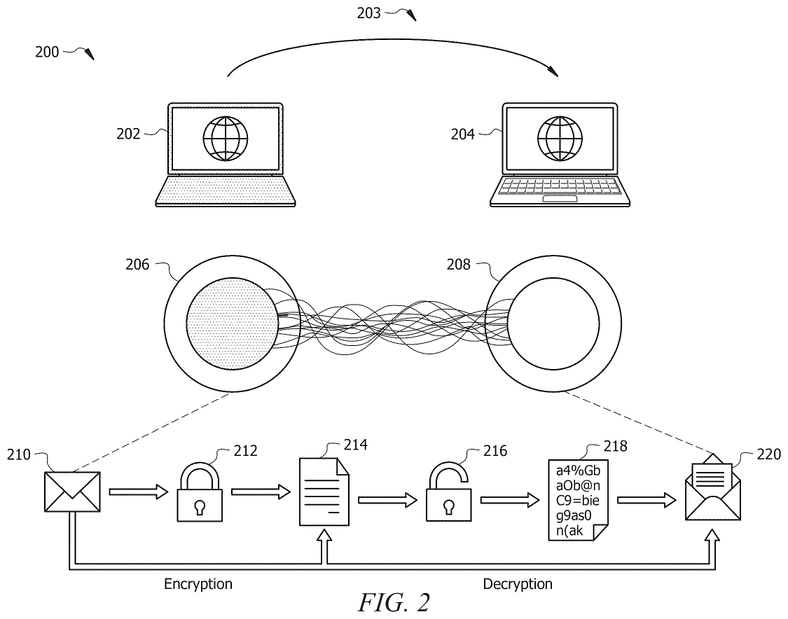

In particular embodiments, the computing device 102 may include a quantum computing device 102 suitable for executing superposed and entangled QuBit based parallel processing operations. For example, in particular embodiments, as will be further discussed below with respect to FIG. 2, the quantum computing device 102 may be utilized by the user 104 to communicate and exchange data over the network 106 or an optical communication channel 133 to the quantum computing system 109 and/or the cloud computing system 108. For example, as will be discussed in greater detail below, the quantum computing device 102 may receive, over the optical communication channel 133, a first quantum cryptographic key 122 from the quantum computing system 109 and may provide, over the optical communication channel 133, a second set of measurements 126 upon which a second quantum cryptographic key 128 may be generated and shared between the quantum computing system 109 and the quantum computing device 102.

In particular embodiments, the optical communication channel 133 may include one or more of an optical fiber link (e.g., one or more fiber optic cables) or a free-space optical link (e.g., photons of light emitted through free space) that may be established between the quantum computing device 102 and the quantum computing system 109. The quantum computing device 102 may further receive over the optical communication channel 133 encoded sensitive data 131 that may be encoded and encrypted by the quantum computing system 109 in accordance with the principles of quantum entanglement. In some embodiments, the first quantum cryptographic key 122, the second set of measurements 126, the second quantum cryptographic key 128, and the encoded sensitive data 131 may be transmitted between the quantum computing system 109 and the quantum computing device 102 and over the optical communication channel 133 as one or more rays or streams of photons of light or entangled photons of light.

### Cloud Computing System

The cloud computing system 108 may include any computing that may be utilized to process data and communicate with other components of the system 100 via the network 106. In one embodiment, the cloud computing system 108 may include a classical computing system suitable for executing binary or bitwise processing operations. As depicted, the cloud computing system 108 may include a processor 110 in signal communication with a memory 114 and a network interface 112.

Processor 110 may include one or more processors operably coupled to the memory 114. The processor 110 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 110 may be a programmable logic device, a microcontroller, a microprocessor, or any suitable combination of the preceding. The one or more processors 110 may be utilized to process data and may be implemented in hardware or software.

For example, the processor 110 may be 8-bit, 16-bit, 32-bit, 64-bit, or of any other suitable architecture. The one or more processors 110 may be utilized to implement various software instructions to perform the operations described herein. For example, the one or more processors 110 may be utilized to execute software instructions 116 and perform one or more functions described herein. In one embodiment, the processor 110 may be understood to be a classical processor.

Network interface 112 may be utilized to enable wired and/or wireless communications (e.g., via network 106). The network interface 112 is configured to communicate data between the cloud computing system 108 and other components of the system 100. For example, the network interface 112 may include a WIFI interface, a local area network (LAN) interface, a wide area network (WAN) interface, a modem, a switch, or a router. The processor 110 may be utilized to send and receive data using the network interface 112. The network interface 112 may be utilized to use any suitable type of communication protocol as would be appreciated by one of ordinary skill in the art.

Memory 114 may be volatile or non-volatile and may include a read-only memory (ROM), random-access memory (RAM), ternary content-addressable memory (TCAM), dynamic random-access memory (DRAM), and static random-access memory (SRAM). Memory 114 may be implemented using one or more disks, tape drives, solid-state drives, and/or the like. The memory 114 may store any of the information described in FIGS. 1-3 along with any other data, instructions, logic, rules, or code operable to implement the function(s) described herein. The memory 114 is operable to store software instructions 116, and/or any other data and instructions.

The software instructions 116 may include any suitable set of software instructions, logic, rules, or code operable to be executed by the processor 110. In particular embodiments, the memory 114 may further store a database 118, which may include a structured data base (e.g., structured query language (SQL) database, a non-SQL database, or other similar relational database), an unstructured database, a sorted data structure, or an unsorted data structure. In one embodiment, the memory 114 may be understood to be a classical memory. In one embodiment, the memory 114 may include a non-transitory computer-readable medium. In particular embodiments, the database 118 may be utilized to store the sensitive data 127 and the unique random key 125 as one or more classical binary bits of data.

### Quantum Computing System

The quantum computing system 109 may include any quantum computing system that may be utilized to process data and communicate with other components of the system 100 via the network 106 and/or the optical communication channel 133. In one embodiment, the quantum computing system 109 may include a quantum computing system suitable for executing superposed and entangled or quantum bit (QuBit) based parallel processing operations. As depicted, the quantum computing system 109 may include a quantum processor 129, a classical processor 130, and an interface 134 in signal communication with a quantum memory 148.

The quantum processor 129 may include one or more quantum processors operably coupled to the quantum memory 148. The quantum processor 129 is configured to process quantum bits (QuBits). The quantum processor 129 may include a superconducting quantum device (with QuBits implemented by states of Josephson junctions), a trapped ion device (with qubits implemented by internal states of trapped ions), a trapped neutral atom device (with QuBits implemented by internal states of trapped neutral atoms), a photon-based device (with QuBits implemented by modes of photons), or any other suitable device that implements quantum bits with states of a respective quantum system.

In particular embodiments, the quantum processor 129 may be a quantum processing unit (QPU), which may include a number of quantum registers, a dedicated quantum memory, and a number of quantum logic gates (e.g., a quantum logic gate, a Hadamard logic gate, a Pauli-X logic gate, a Pauli-Y logic gate, a Pauli-Z logic gate, a controlled NOT logic gate, and so forth) suitable for executing superposed and entangled or quantum bit (QuBit) based parallel processing operations.

In particular embodiments, the quantum processor 129 may be further utilized to perform quantum computations, such as quantum annealing, quantum simulations, and universal quantum computing. For example, in particular embodiments, the quantum processor 129 may, in conjunction with the quantum memory 148 and utilizing the quantum hardware 132, execute one or more classical machine-learning (CML) models 152, one or more quantum machine-learning (QML) models 154, one or more quantum circuits 156, one or more quantum algorithms 158, and/or one or more quantum assembly languages 160 for performing operations on the first quantum cryptographic key 122, the first set of measurements 124, the second set of measurements 126, the second quantum cryptographic key 128, the sensitive data 127, the unique random key 125, and the encoded sensitive data 131.

For example, in some embodiments, the first set of measurements 124 of one or more pairs of entangled QuBits and the second set of measurements 126 of one or more pairs of entangled QuBits may be utilized to generate the second quantum cryptographic key 128, which may be shared between the quantum computing system 109 and the quantum computing device 102 for securing all communications between the quantum computing system 109 and the quantum computing device 102. Further, the quantum computing system 109 may encode the sensitive data 127 by generating one or more pairs of entangled Qubits and utilizing the one or more pairs of entangled Qubits to generate the encoded sensitive data 131. The quantum computing system 109 may then further encrypt the underlying sensitive message (e.g., plaintext message) included in the encoded sensitive data 131 utilizing the second quantum cryptographic key 128 and the unique random key 125.

In particular embodiments, the one or more classical machine-learning (CML) models 152 may include, for example, one or more of a spiking neural network (SNN), an autoencoder (AE), a variational autoencoder (VAE), a generative adversarial network (GAN), a convolutional neural network (CNN), a deep neural network (DNN), a deep convolutional neural network (DCNN), a graph neural network (GNN), a graph convolutional network (GCN), a bidirectional and auto-regressive transformer (BART) model, a bidirectional encoder representations for transformer (BERT) model, a generative pre-trained transformer (GPT) model, a graph transformer, or other similar machine-learning model. In another embodiment, the one or more classical machine-learning (CML) models 152 may include one or more language models (LMs) or large language model (LLMs).

Similarly, in particular embodiments, the one or more quantum machine-learning (QML) models 154 may include one or more of a quantum-enhanced machine-learning model, a quantum-inspired machine-learning model, a quantum-generalized machine-learning model, or any of various other machine-learning models in which the processing power of quantum computing and the properties of quantum physics are utilized to accelerate machine-learning tasks. Specifically, it should be appreciated that the quantum computing system 109 may be capable of executing both the one or more classical machine-learning (CML) models 152 and the one or more quantum machine-learning (QML) models 154 in accordance with the presently disclosed embodiments. On the other hand, the cloud computing system 108 may be capable of executing only the one or more classical machine-learning (CML) models 152.

In particular embodiments, the quantum hardware 132 may include, for example, a number of quantum bits (QuBits), a number of QuBit connectors, a number of QuBit interconnector circuits for control operations, and a quantum random access memory (QRAM). The one or more quantum circuits 156 may include a sequence of quantum logic gates suitable for representing and expressing each step of the one or more one or more quantum algorithms 158. For example, the one or more quantum algorithms 158 may include any of various quantum algorithms, such as quantum annealing algorithms, quantum simulation algorithms, quantum search algorithms (e.g., Grover's algorithm), quantum cryptography algorithms (e.g., Shor's algorithm, Deutsch-Jozsa Algorithm, Harrow-Hassidim-Lloyd (HHL) algorithm, Quantum Monte Carlo algorithm, and so forth), one or more quantum Fourier transform (QFT) based algorithms or inverse quantum Fourier transform (iQFT) based algorithms, one or more classical quantum hybrid algorithms (e.g., Quantum Eigensolver), one or more classical quantum variational algorithms, one or more post-quantum cryptographic algorithms (e.g., quantum-resistant encryption algorithms), and/or other user-developed quantum algorithms that may be represented by instructions 150.

The classical processor 130 may include one or more processors operably coupled to the quantum memory 148. The classical processor 130 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The classical processor 130 may be a programmable logic device, a microcontroller, a microprocessor, or any suitable combination of the preceding. The one or more processors are configured to process data and may be implemented in hardware or software. For example, the classical processor 130 may be 8-bit, 16-bit, 32-bit, 64-bit, or of any other suitable architecture. The one or more processors are configured to implement various software instructions to perform the operations described herein.

The interface 134 may be utilized to convert data items represented by classical binary bits of data into to quantum bits (QuBits) of data. For example, in some embodiments, the interface 134 may convert first quantum cryptographic key 122 data represented as classical binary bits of data into quantum data 142 for further processing, and, similarly, convert the second set of measurements 126 represented as classical binary bits of data into quantum data 144 for further processing, for example. In particular embodiments, the quantum data 142 and the quantum data 144 may represent one or more pairs of entangled QuBits.

In particular embodiments, the interface 134 may be further utilized to convert data items represented by QuBits into classical binary bits of data. For example, in particular embodiments, upon the quantum computing system 109 extracting data from the first quantum cryptographic key 122 based on the quantum data 142, the interface 134 may convert the quantum data 142 representing the first quantum cryptographic key 122 into classical binary bits of data representing the first set of measurements 124. Likewise, upon the quantum computing system 109 receiving the second set of measurements 126 and extracting data therefrom based on the quantum data 144, the interface 134 may convert the quantum data 144 representing the second set of measurements 126 into classical binary bits of data representing the second quantum cryptographic key 128.

In particular embodiments, the interface 134 may include a number of components 136 that may be utilized to generate and manipulate quantum bits (QuBits). In the illustrated embodiment, the number of components 136 and the quantum processor 129 are configured to operate on a same type of quantum bits (QuBits). For example, when the quantum processor 129 includes a photon-based device (with QuBits implemented by modes of photons), the number of components 136 may include optical components such as lasers, mirrors, prisms, waveguides, interferometers, optical fibers, filters, polarizers, and/or lenses. In particular embodiments, the number of components 136 may further include one or more quantum-based light sources, such as one or more semiconductor quantum dots (QDs), a high-intensity laser, a quantum particle generator, or other similar quantum-based light source that may be utilized to generate one or more pairs of entangled QuBits.

For example, in accordance with presently disclosed embodiments, the quantum computing system 109 may utilize the number of components 136 to generate one or more pairs of entangled quantum bits QuBits, in which the one or more pairs of entangled QuBits includes the encoded sensitive data 131. Specifically, in particular embodiments, the quantum computing system 109 may access or generate the second quantum cryptographic key 128 and the sensitive data 127 to be transmitted to the quantum computing device 102. The quantum computing system 109 may then transmit, over the optical communication channel 133, the second quantum cryptographic key 128 to the quantum computing device 102.

In response to transmitting the second quantum cryptographic key 128 to the quantum computing device 102, the quantum computing system 109 may then encode the sensitive data 127 based on the second quantum cryptographic key 128 and the unique random key 125 and generate the encoded sensitive data 131. In accordance with presently disclosed embodiments, the encoded sensitive data 131 may include a generated one or more pairs of entangled Qubits. The quantum computing system 109 may then transmit, over the optical communication channel 133, the encoded sensitive data 131 to the quantum computing device 102.

Quantum memory 148 may include a quantum read-only memory (QROM), quantum random-access memory (QRAM), or other similar quantum memory. The quantum memory 148 may store any of the information described in FIGS. 1 and 2 along with any other data, instructions, logic, rules, or code operable to implement the function(s) described herein. The quantum memory 148 is operable to store software instructions 150, and/or any other data and instructions. The software instructions 150 may include any suitable set of software instructions, logic, rules, or code operable to be executed by the quantum processor 129. In one embodiment, the quantum memory 148 may include a non-transitory computer-readable medium.

In another embodiment, the quantum memory 148 may include a quantum storage medium, which may be utilized to store the one or more pairs of entangled QuBits once generated by the one or more quantum light sources (e.g., semiconductor QDs, high-intensity laser, quantum particle generator). For example, in one embodiment, the quantum memory 148 may include, for example, a cryogenic storage medium, a nitrogen-vacancy (N-V) center in diamond storage medium, one or more rare-earth-ion-doped crystals, one or more quantum dots (QDs), a quantum optical memory (QOM), one or more superconducting QuBits, a controlled reversible inhomogeneous broadening of a single atomic absorption line (CRIB) storage medium, or other similar quantum storage medium.

### Encoding and Encrypting Sensitive Data Based on Quantum Entanglement

Embodiments of the present disclosure discuss techniques for encoding and encrypting sensitive data based on quantum entanglement.

FIG. 2 illustrates a diagram of a quantum entanglement based encoding and encryption architecture 200 for encrypting sensitive data based on quantum entanglement, in accordance with certain aspects of the present disclosure. In one embodiment, the quantum entanglement based encoding and encryption architecture 200 may be a further illustrative example of the combined classical computing and quantum computing system 100 as described above with respect to FIG. 1.

As depicted, the quantum entanglement based encoding and encryption architecture 200 may include a sender quantum computing system 202, a receiver quantum computing system 204 that may be optically coupled to the sender quantum computing system 202 by way of an optical communication channel 203, and one or more pairs of entangled QuBits 206, 208. In one embodiment, the sender quantum computing system 202 may correspond to the computing device 102, the receiver quantum computing system 204 may correspond to the quantum computing system 109, and the optical communication channel 203 may correspond to the optical communication channel 133, as all described above with respect to FIG. 1. Furthermore, in accordance with the presently disclosed embodiments, the sender quantum computing system 202 and the receiver quantum computing system 204 may each include one or more quantum processors, such as the quantum processor 129 as further described above with respect to FIG. 1.

In particular embodiments, the sender quantum computing system 202 may generate the one or more pairs of entangled QuBits 206, 208 utilizing, for example, one or more quantum-based light sources, such as one or more semiconductor quantum dots (QDs), a high-intensity laser, a quantum particle generator, or other similar quantum-based light source. For example, in particular embodiments, the sender quantum computing system 202 may generate the one or more pairs of entangled QuBits 206, 208 and utilize the one or more pairs of entangled QuBits 206, 208 to encode the encoded sensitive data 210 (e.g., an encoded sensitive message).

In accordance with the presently disclosed embodiments, the one or more pairs of entangled QuBits 206, 208 may create a quantum entanglement system (e.g., an entangled state) with respect to the encoded sensitive data 210 (e.g., transmitted at the sender quantum computing system 202) and the corresponding decoded sensitive data 220 (e.g., the receiver quantum computing system 204), such that as the encoded sensitive data 210 is transmitted from the sender quantum computing system 202 to the receiver quantum computing system 204 over the optical communication channel 203 (e.g., optical fiber link, free-space optical link), any unauthorized observance (e.g., a measurement) of even one entangled QuBit of each pair of the one or more pairs of entangled QuBits 206, 208 may be identified and detected by the sender quantum computing system 202. In such an instance, the sender quantum computing system 202 may then destroy (e.g., render unreadable, indecipherable, or inoperable) one or more of a secret quantum cryptographic key (e.g., second quantum cryptographic key 228) shared between the sender quantum computing system 202 and the receiver quantum computing system 204, the one or more pairs of entangled QuBits 206, 208, and a unique random key 212.

In particular embodiments, the optical communication channel 203 (e.g., optical fiber link, free-space optical link) may be established between the sender quantum computing system 202 and the receiver quantum computing system 204 by the sender quantum computing system 202 first identifying a secret quantum cryptographic key (e.g., second quantum cryptographic key 228) to be shared between the sender quantum computing system 202 and the receiver quantum computing system 204. In particular embodiments, the sender quantum computing system 202 may then transmit the secret quantum cryptographic key (e.g., second quantum cryptographic key 228) to the receiver quantum computing system 204 for securing communications between the sender quantum computing system 202 and the receiver quantum computing system 204.

In particular embodiments, upon the sender quantum computing system 202 encoding the encoded sensitive data 210 (e.g., an encoded sensitive message) based on the one or more pairs of entangled QuBits 206, 208, the sender quantum computing system 202 may then further encrypt the encoded sensitive data 210 utilizing the secret quantum cryptographic key (e.g., second quantum cryptographic key 228) and a unique random key 212 for encrypting a plaintext message 214 into a ciphertext message 218 to be transmitted over the optical communication channel 203 to the receiver quantum computing system 204.

Specifically, while the one or more pairs of entangled QuBits 206, 208 may be utilized to encode the encoded sensitive data 210 and the decoded sensitive data 220 into one or more pairs of entangled QuBits, the secret quantum cryptographic key (e.g., second quantum cryptographic key 228) and the unique random key 212 may be utilized to further encrypt the underlying sensitive message (e.g., plaintext message 214) included in the encoded sensitive data 210 and the decoded sensitive data 220. In this way, a quantum state of each entangled QuBit of each pair of the one or more pairs of entangled QuBits representing the encoded sensitive data 210 may be inextricably associated with the underlying sensitive message (e.g., plaintext message 214) being encrypted, such that any unauthorized observance (e.g., a measurement) of an entangled QuBit may indicate a security compromise of the underlying sensitive message (e.g., plaintext message 214).

In particular embodiments, the unique random key 212 may include, for example, a cryptographic key generated in accordance with a one-time pad (OTP) encryption process. For example, in one embodiment, the sender quantum computing system 202 may generate the unique random key 212 utilizing a random quantum cryptographic key having an equal length to the plaintext message 214, such that, for example, each entangled QuBit of each of the one or more pairs of entangled QuBits 206, 208 representing the underlying plaintext message 214 may be encrypted individually. In another embodiment, the sender quantum computing system 202 may generate the unique random key 212 utilizing a random quantum cryptographic key having a length of one-half the length of the plaintext message 214, such that, for example, only one entangled QuBit of each of the one or more pairs of entangled QuBits 206, 208 representing the underlying plaintext message 214 may be encrypted individually.

In particular embodiments, upon the sender quantum computing system 202 generating the ciphertext message 218 and transmitting the encoded sensitive data 210 to the receiver quantum computing system 204, the receiver quantum computing system 204 may then decode the encoded sensitive data 210 utilizing the secret quantum cryptographic key (e.g., second quantum cryptographic key 228) into decoded sensitive data 220 and further decrypt the ciphertext message 218 into the plaintext message 214 utilizing a unique random key 216. In particular embodiments, the unique random key 216 utilized to decrypt the ciphertext message 218 may be identical to the unique random key 212 utilized to encrypt the plaintext message 214.

In particular embodiments, upon the sender quantum computing system 202 utilizing the unique random key 212 to encrypt the plaintext message 214 into the ciphertext message 218, the sender quantum computing system 202 may then destroy (e.g., render unreadable, indecipherable, or inoperable) the unique random key 212. Similarly, upon the receiver quantum computing system 204 utilizing the unique random key 216 to decrypt the ciphertext message 218 back into the plaintext message 214, the receiver quantum computing system 204 may then destroy the unique random key 216.

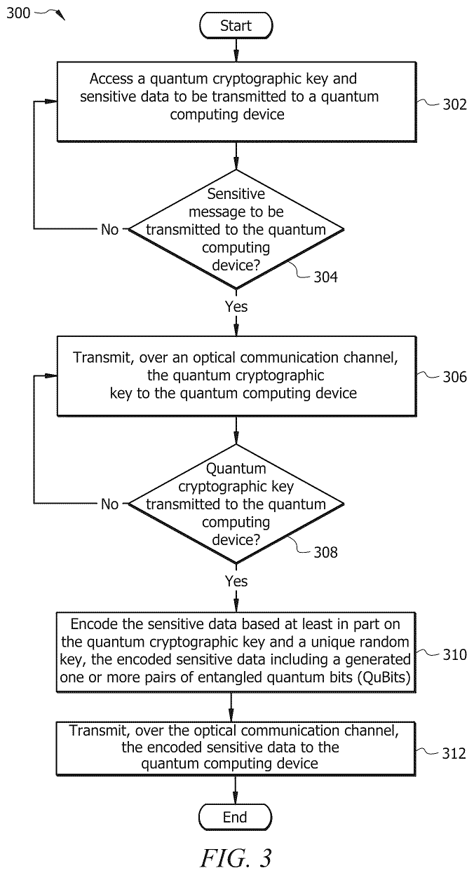

FIG. 3 illustrates a flowchart of an example method 300 for encoding and encrypting sensitive data based on quantum entanglement, in accordance with one or more embodiments of the present disclosure. The method 300 may be performed by the combined classical computing and quantum computing system 100 as described above with respect to FIG. 1. For example, in one embodiment, the method 300 may be performed by the quantum computing system 109 alone. In another embodiment, the method 300 may be performed in conjunction by the quantum computing device 102 and the quantum computing system 109.

The method 300 may begin at block 302 with the quantum computing system 109 accessing a quantum cryptographic key (e.g., second quantum cryptographic key 228) and sensitive data 127 to be transmitted to a quantum computing device 102. In particular embodiments, the method 300 may continue at decision 304 with the quantum computing system 109 confirming whether a sensitive message (e.g., encoded sensitive data 210) is to be transmitted to a quantum computing device (e.g., receiver quantum computing system 204).

In particular embodiments, in response to confirming that no sensitive message (e.g., encoded sensitive data 210) is to be transmitted to the quantum computing device (e.g., at decision 304), the method 300 may return to block 302. On the other hand, in response to confirming that the sensitive message (e.g., encoded sensitive data 210) is to be transmitted to the quantum computing device (e.g., at decision 304), the method 300 may continue at block 306 with the quantum computing system 109 transmitting, over an optical communication channel 203, the quantum cryptographic key (e.g., second quantum cryptographic key 228) to the quantum computing device (e.g., receiver quantum computing system 204).

For example, in one embodiment, the optical communication channel 203 (e.g., optical fiber link, free-space optical link) may be established between the sender quantum computing system 202 and the receiver quantum computing system 204 by the sender quantum computing system 202 first identifying a secret quantum cryptographic key (e.g., second quantum cryptographic key 228) to be shared between the sender quantum computing system 202 and the receiver quantum computing system 204. The sender quantum computing system 202 may then transmit the secret quantum cryptographic key (e.g., second quantum cryptographic key 228) to the receiver quantum computing system 204 for securing communications between the sender quantum computing system 202 and the receiver quantum computing system 204.

In particular embodiments, the method 300 may continue at decision 308 with the quantum computing system 109 confirming whether the quantum cryptographic key (e.g., second quantum cryptographic key 228) has been transmitted to the quantum computing device (e.g., receiver quantum computing system 204). In particular embodiments, in response to confirming that the quantum cryptographic key (e.g., second quantum cryptographic key 228) has not been transmitted to the quantum computing device (e.g., at decision 308), the method 300 may return to block 306.

On the other hand, in response to confirming that the quantum cryptographic key (e.g., second quantum cryptographic key 228) has been transmitted to the quantum computing device (e.g., at decision 308), the method 300 may then continue at block 310 with the quantum computing system 109 encoding the sensitive data (e.g., encoded sensitive data 210) based at least in part on the quantum cryptographic key (e.g., second quantum cryptographic key 228) and a unique random key (e.g., unique random key 212), in which the encoded sensitive data 210 includes a generated one or more pairs of entangled quantum bits (QuBits) 206, 208.

For example, in particular embodiments, the one or more pairs of entangled QuBits 206, 208 may be utilized to encode the encoded sensitive data 210 and the decoded sensitive data 220 into one or more pairs of entangled QuBits. The secret quantum cryptographic key (e.g., second quantum cryptographic key 228) and the unique random key 212 may be utilized to further encrypt the underlying sensitive message (e.g., plaintext message 214) included in the encoded sensitive data 210 and the decoded sensitive data 220.

In particular embodiments, the method 300 may then conclude at block 312 with the quantum computing system 109 transmitting, over the optical communication channel 203, the encoded sensitive data to the quantum computing device. For example, in particular embodiments, upon the sender quantum computing system 202 generating the ciphertext message 218 and transmitting the encoded sensitive data 210 to the receiver quantum computing system 204, the receiver quantum computing system 204 may then decode the encoded sensitive data 210 utilizing the secret quantum cryptographic key (e.g., second quantum cryptographic key 228) into decoded sensitive data 220 and further decrypt the ciphertext message 218 into the plaintext message 214 utilizing a unique random key 216.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a quantum memory configured to store a quantum cryptographic key, a unique random key, and sensitive data to be transmitted to a quantum computing device over an optical communication channel; and
one or more quantum processors operably coupled to the quantum memory and configured to:
access the quantum cryptographic key and the sensitive data to be transmitted to the quantum computing device;
transmit, over the optical communication channel, the quantum cryptographic key to the quantum computing device;
in response to transmitting the quantum cryptographic key to the quantum computing device, encode the sensitive data based at least in part on the quantum cryptographic key and the unique random key, wherein the encoded sensitive data comprises a generated one or more pairs of entangled quantum bits (Qubits); and
transmit, over the optical communication channel, the encoded sensitive data to the quantum computing device.

2. The system of claim 1, wherein the sensitive data comprises a sensitive message to be transmitted to the quantum computing device, and wherein the one or more quantum processors are further configured to:
encode the sensitive data based at least in part on the quantum cryptographic key and the unique random key to generate a ciphertext message; and
transmit, over the optical communication channel, the ciphertext message to the quantum computing device.

3. The system of claim 2, wherein the one or more quantum processors are further configured to encode the sensitive data based at least in part on the quantum cryptographic key and the unique random key to generate the ciphertext message in accordance with a one-time pad (OTP) encryption process.

4. The system of claim 1, wherein the one or more quantum processors are further configured to:
prior to encoding the sensitive data based at least in part on the quantum cryptographic key and the unique random key:
identify, based at least in part on one Qubit of each pair of the one or more pairs of entangled QuBits, an observance of the quantum cryptographic key during the transmission of the quantum cryptographic key to the quantum computing device; and
in response to identifying the observance of the quantum cryptographic key, destroy the quantum cryptographic key.

5. The system of claim 1, wherein the one or more quantum processors are further configured to:
generate the unique random key; and
subsequent to encoding the sensitive data based at least in part on the quantum cryptographic key and the unique random key, destroy the unique random key.

6. The system of claim 1, wherein the one or more pairs of entangled Qubits comprises one or more of a plurality of entangled photons, a plurality of entangled electrons, a plurality of entangled neuronal impulses, or a plurality of entangled subatomic particles.

7. The system of claim 1, wherein the quantum computing device is configured to receive the transmission of the encoded sensitive data and to decrypt the encoded sensitive data based at least in part on the quantum cryptographic key and the unique random key.

8. A method, comprising:
accessing a quantum cryptographic key and sensitive data to be transmitted to a quantum computing device over an optical communication channel;
transmitting, over the optical communication channel, the quantum cryptographic key to the computing device;
in response to transmitting the quantum cryptographic key to the computing device, encoding the sensitive data based at least in part on the quantum cryptographic key and a unique random key, wherein the encoded sensitive data comprises a generated one or more pairs of entangled quantum bits (Qubits); and
transmitting, over the optical communication channel, the encoded sensitive data to the quantum computing device.

9. The method of claim 8, wherein the sensitive data comprises a sensitive message to be transmitted to the quantum computing device, the method further comprising:
encoding the sensitive data based at least in part on the quantum cryptographic key and the unique random key to generate a ciphertext message; and
transmitting, over the optical communication channel, the ciphertext message to the quantum computing device.

10. The method of claim 9, further comprising encoding the sensitive data based at least in part on the quantum cryptographic key and the unique random key to generate the ciphertext message in accordance with a one-time pad (OTP) encryption process.

11. The method of claim 8, further comprising:
prior to encoding the sensitive data based at least in part on the quantum cryptographic key and the unique random key:
identifying, based at least in part on one Qubit of each pair of the one or more pairs of entangled QuBits, an observance of the quantum cryptographic key during the transmission of the quantum cryptographic key to the quantum computing device, an observance of the quantum cryptographic key during the transmission of the quantum cryptographic key to the quantum computing device; and
in response to identifying the observance of the quantum cryptographic key, destroying the quantum cryptographic key.

12. The method of claim 8, further comprising:
generating the unique random key; and
subsequent to encoding the sensitive data based at least in part on the quantum cryptographic key and the unique random key, destroying the unique random key.

13. The method of claim 8, wherein the one or more pairs of entangled Qubits comprises one or more of a plurality of entangled photons, a plurality of entangled electrons, a plurality of entangled neuronal impulses, or a plurality of entangled subatomic particles.

14. The method of claim 8, wherein the quantum computing device is configured to receive the transmission of the encoded sensitive data and to decrypt the encoded sensitive data based at least in part on the quantum cryptographic key and the unique random key.

15. A non-transitory computer-readable medium storing instructions that, when executed by one or more quantum processors, cause the one or more quantum processors to:
access a quantum cryptographic key and sensitive data to be transmitted to a quantum computing device over an optical communication channel;
transmit, over the optical communication channel, the quantum cryptographic key to the computing device;
in response to transmitting the quantum cryptographic key to the computing device, encode the sensitive data based at least in part on the quantum cryptographic key and a unique random key, wherein the encoded sensitive data comprises a generated one or more pairs of entangled quantum bits (Qubits); and
transmit, over the optical communication channel, the encoded sensitive data to the quantum computing device.

16. The non-transitory computer-readable medium of claim 15, wherein the sensitive data comprises a sensitive message to be transmitted to the quantum computing device, and wherein the instructions further cause the one or more quantum processors to:
encode the sensitive data based at least in part on the quantum cryptographic key and the unique random key to generate a ciphertext message; and
transmit, over the optical communication channel, the ciphertext message to the quantum computing device.

17. The non-transitory computer-readable medium of claim 16, wherein the instructions further cause the one or more quantum processors to encode the sensitive data based at least in part on the quantum cryptographic key and the unique random key to generate the ciphertext message in accordance with a one-time pad (OTP) encryption process.

18. The non-transitory computer-readable medium of claim 15, wherein the instructions further cause the one or more quantum processors to:
prior to encoding the sensitive data based at least in part on the quantum cryptographic key and the unique random key:
identify, based at least in part on one Qubit of each pair of the one or more pairs of entangled QuBits, an observance of the quantum cryptographic key during the transmission of the quantum cryptographic key to the quantum computing device; and
in response to identifying the observance of the quantum cryptographic key, destroy the quantum cryptographic key.

19. The non-transitory computer-readable medium of claim 15, wherein the instructions further cause the one or more quantum processors to:
generate the unique random key; and
subsequent to encoding the sensitive data based at least in part on the quantum cryptographic key and the unique random key, destroy the unique random key.

20. The non-transitory computer-readable medium of claim 15, wherein the one or more pairs of entangled Qubits comprises one or more of a plurality of entangled photons, a plurality of entangled electrons, a plurality of entangled neuronal impulses, or a plurality of entangled subatomic particles.
